(19) United States
(12) Patent Application Publication
(10) Pub. No.: US 2018/0278407 A1
(43) Pub. Date: Sep. 27, 2018

(54) WIRELESS COMMUNICATION APPARATUS, SENSING APPARATUS AND SIGNAL PROCESSING SYSTEM

(71) Applicant: KABUSHIKI KAISHA TOSHIBA, Tokyo (JP)

(72) Inventors: Akihide SAI, Yokohama (JP); Hidenori OKUNI, Yokohama (JP); Masanori FURUTA, Odawara (JP); Satoshi KONDO, Kawasaki (JP)

(21) Appl. No.: 15/706,963

(22) Filed: Sep. 18, 2017

(30) Foreign Application Priority Data
Mar. 21, 2017 (JP) 2017-054970

(51) Int. Cl. H04L 7/00; H04L 7/033; H04L 7/04

(52) U.S. Cl. CPC H04L 7/0091; H04L 7/0087; H04L 7/042; H04L 7/0331

(57) ABSTRACT

A wireless communication apparatus has a transmitter, a signal processor, and ADPLL circuitry. The transmitter to modulate transmission data using a local oscillation signal to generate a wireless signal to be transmitted from an antenna. The signal processor to generate the transmission data and to supply the generated transmission data to the transmitter. The ADPLL (All Digital Phase-Locked Loop) circuitry to generate the local oscillation signal by ADPLL processing and to supply digital information correlated with an input sensing signal to the signal processor.

### CROSS REFERENCE TO RELATED APPLICATIONS

This application is based upon and claims the benefit of priority from the prior Japanese Patent Application No. 2017-54970, filed on Mar. 21, 2017, the entire contents of which are incorporated herein by reference.

### FIELD

Embodiments relate to a wireless communication apparatus, a sensing apparatus, and a signal processing system.

### BACKGROUND

A technique using an AE (Acoustic Emission) sensor to examine degradation of structures, such as bridge piers, is considered. The AE sensor emits strain energy stored in a material as elastic waves when the material is deformed or cracks. A detectable range with one AE sensor is limited. Therefore, in the case of a gigantic structure, AE sensors are installed in different locations of the structure. Data detected by the respective AE sensors is collected by a signal processor periodically, to determine the degree of degradation of the structure.

In the case where there are many AE sensors or the distance from an AE sensor to the signal processor is long, it is not practical to transmit detected data of each AE sensor in wired transmission. Accordingly, it is considered to transmit the detected data of each AE sensor in wireless transmission. However, transmission of a signal in wireless transmission requires more power as the distance becomes longer, and the signal is more susceptible to noises.

### BRIEF DESCRIPTION OF THE DRAWINGS

FIG. 1 is a block diagram schematically showing the configuration of a wireless communication apparatus according to a first embodiment;

FIG. 2 is a block diagram schematically showing the configuration of a wireless communication apparatus according to a second embodiment;

FIG. 3 is a block diagram schematically showing the configuration of a wireless communication apparatus according to a third embodiment;

FIG. 4 is a block diagram schematically showing the configuration of a wireless communication apparatus according to a fourth embodiment;

FIG. 5 is a block diagram schematically showing the configuration of a wireless communication apparatus according to a fifth embodiment;

FIG. 6 is a block diagram schematically showing the configuration of a wireless communication apparatus according to a sixth embodiment;

FIG. 7 is a block diagram schematically showing the configuration of a sensing apparatus; and

FIG. 8 is a block diagram schematically showing the configuration of a signal processing system.

### DETAILED DESCRIPTION

According to one embodiment, a wireless communication apparatus has a transmitter, a signal processor, and ADPLL circuitry. The transmitter to modulate transmission data using a local oscillation signal to generate a wireless signal to be transmitted from an antenna. The signal processor to generate the transmission data and to supply the generated transmission data to the transmitter. The ADPLL (All Digital Phase-Locked Loop) circuitry to generate the local oscillation signal by ADPLL processing and to supply digital information correlated with an input sensing signal to the signal processor.

Hereinafter, embodiments of the present invention will be explained with reference to the drawings. In the accompanying drawings of the present specification, for simplicity of drawings and easy understanding, the scale, the ratio of height to width, etc. are appropriately modified or enlarged from actual ones.

Shapes and geometrical conditions, and also their degrees used in this specification are defined. For example, the terms such as “parallel”, “orthogonal” and “the same”, the values of length and angle, etc. are, not to be limited to the strict sense of the terms, but interpreted to such an extent that a similar function can be expected.

### First Embodiment

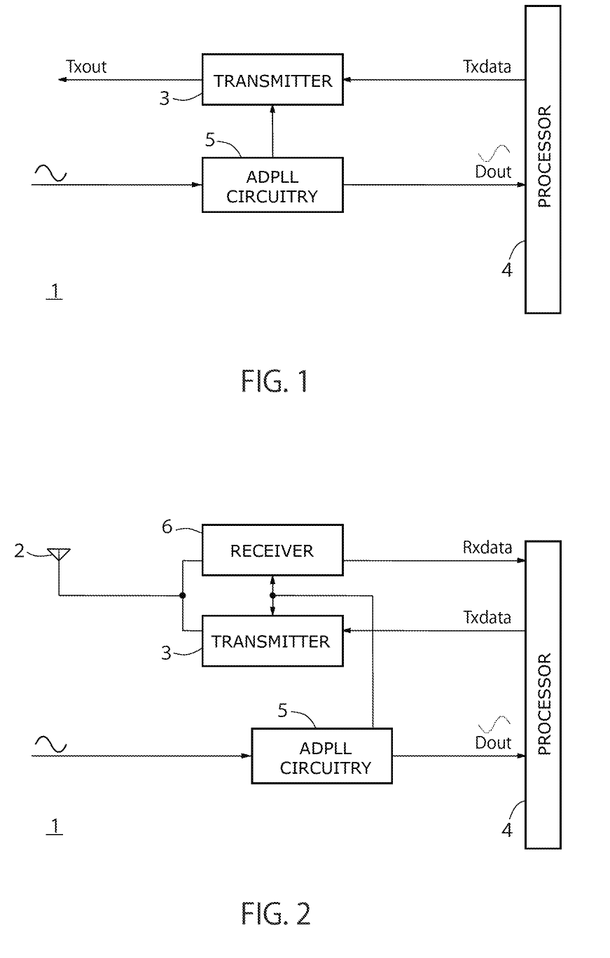

FIG. 1 is a block diagram schematically showing the configuration of a wireless communication apparatus 1 according to a first embodiment. The wireless communication apparatus 1 of FIG. 1 is provided with a transmitter 3, a microprocessor 4, and ADPLL circuitry 5. The transmitter 3 modulates transmission data using a local oscillation signal to generate a wireless signal to be transmitted from an antenna not shown in FIG. 1. The microprocessor 4 is a signal processor that generates the transmission data and supplies the transmission data to the transmitter 3. Hereinbelow, the microprocessor 4 is simply referred to as a processor 4. The processor 4 may have a function, other than the function as the signal processor. However, the present embodiment will be explained mainly with the function of the processor 4 as the signal processor.

The ADPLL circuitry 5 generates a local oscillation signal to be used by the transmitter 3 in modulation, by ADPLL (All Digital Phase-Locked Loop) processing, and supplies digital information in synchronism with an input sensing signal to the signal processor. The sensing signal is a signal detected by a sensor (not shown). The sensor type is not limited to any particular one. The sensor may, for example, be an AE (Acoustic Emission) sensor that emits strain energy accumulated in a material as an elastic wave, when the material is deformed or cracked. It is a precondition in the present embodiment that, although there is no limitation on the sensor type, the sensing signal is an alternating current signal having varying amplitude.

The transmission data to be supplied to the transmitter 3 by the processor 4 is base-band data. The transmitter 3 converts the transmission data into an RF (Radio Frequency)-band wireless signal, using the local oscillation signal generated by the ADPLL circuitry 5. The ADPLL circuitry 5 has a function of converting time information having an analog value into digital information. The ADPLL circuitry 5 converts the sensing signal into a digital signal. The ADPLL circuitry 5 superimposes the digital signal acquired by digitally-converting the sensing signal on the digital information, when a frequency of an oscillation signal is fed back with the digital information.

The digital information is supplied to the processor 4. Based on the digital information, the processor 4 performs predetermined signal processing on the sensing signal and, based on the result of signal processing, generates transmission data. Then, the processor 4 supplies the generated transmission data to the transmitter 3. In this way, the processor 4 generates transmission data correlated with the sensing signal and supplies the generated transmission data to the transmitter 3.

As described above, after the sensing signal is converted into the digital information and sent to the processor 4, the processor 4 generates the transmission data and transmits the transmission data to the transmitter 3. Then, the transmitter 3 generates a wireless signal in accordance with the transmission data and transmits the wireless signal from the antenna.

As explained later, when converting the sensing signal into the digital information, the ADPLL circuitry 5 generates the digital information so as to cancel out the sensing signal. In more detail, the ADPLL circuitry 5 generates digital information in the reverse phase of the sensing signal. Not only to be supplied to the processor 4, the digital information is used for feedback control of the oscillation frequency of the oscillation signal. By generating the digital information in the reverse phase of the sensing signal, a signal component of the sensing signal is cancelled out, so that ADPLL control, equivalent to ADPLL control with no sensing signal input, can be performed to stabilize the oscillation frequency of the oscillation signal.

As described above, although not provided with an A/D converter for exclusive use in sensing-signal digital conversion, the wireless communication apparatus 1 of FIG. 1 uses the ADPLL circuitry 5 for wireless communication to generate digital information acquired by digitally-converting the sensing signal. Accordingly, without requiring an A/D converter for exclusive use in sensing-signal digital conversion, a wireless communication apparatus 1 having a sensing-signal reading function can be realized with a simple configuration.

### Second Embodiment

A second embodiment has a configuration having an antenna 2 and a receiver 6 added to that of FIG. 1. FIG. 2 is a block diagram schematically showing the configuration of a wireless communication apparatus 1 according to the second embodiment. In addition to the configuration of FIG. 1, the wireless communication apparatus 1 of FIG. 2 is provided with a receiver 6 that demodulates a wireless signal received by an antenna 2 based on a local oscillation signal, to generate reception data. In other words, the receiver 6 converts, by frequency conversion, an RF-band wireless signal received by the antenna 2 into base-band reception data using the local oscillation signal generated by the ADPLL circuitry 5.

Also in the second embodiment, the ADPLL circuitry 5 generates digital information in the reverse phase of the sensing signal and supplies the digital information to the processor 4, and further performs feedback control of the oscillation frequency of the oscillation signal based on the digital information. Since the sensing signal and the digital information are in the reverse phase of each other, the signals cancel out each other to stabilize the oscillation frequency of the oscillation signal. According to the second embodiment, the ADPLL circuitry 5 provided for use in transmission and reception can also be used for digital conversion of the sensing signal and transfer of digitally-converted digital information to the processor 4.

### Third Embodiment

A third embodiment has a detailed internal configuration of the ADPLL circuitry 5 in the second embodiment.

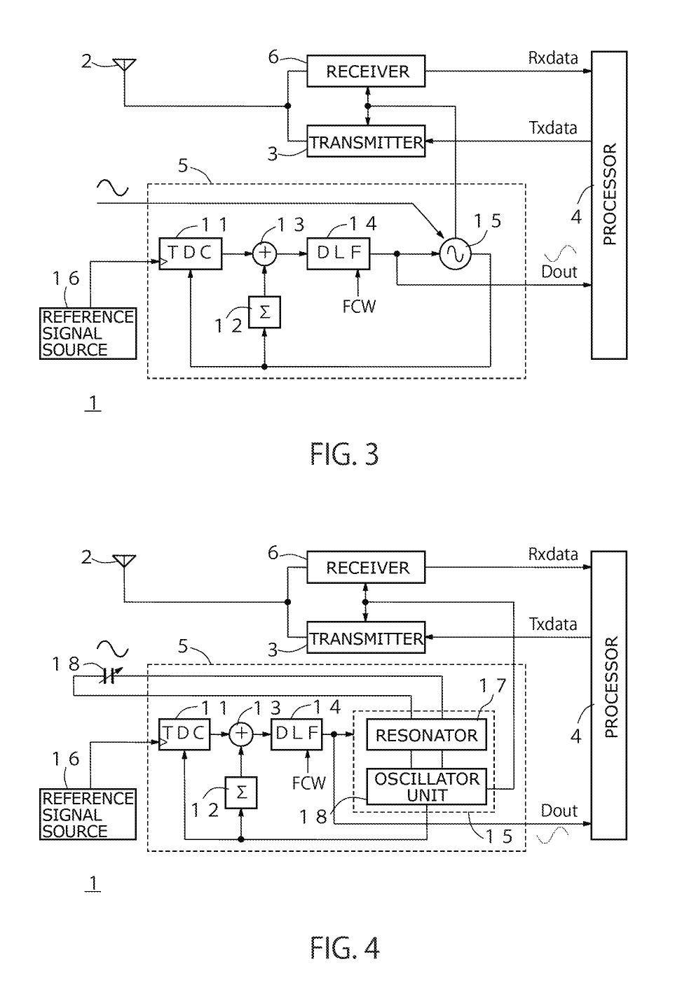

FIG. 3 is a block diagram schematically showing the internal configuration of a wireless communication apparatus 1 according to the third embodiment. The ADPLL circuitry 5 in the wireless communication apparatus 1 of FIG. 3 has a time-to-digital converter (TDC) 11, a counter 12, an adder 13, a digital loop filter (DLF) 14, and a voltage-controlled oscillator (VCO) 15.

The TDC 11 generates a signal acquired by digitally-converting a phase difference between an oscillation signal of the VCO 15 and a reference signal generated by a reference signal source 16. The counter 12 counts the number of rising edges or falling edges of the oscillation signal. In other words, the counter 12 detects an integral phase of the oscillation signal whereas the TDC 11 detects a fractional phase of the oscillation signal.

The adder 13 adds the output of the TDC 11 and the output of the counter 12 to generate digital information. The digital loop filter 14 removes unnecessary high-frequency components included in the digital information. To the digital loop filter 14, a frequency control code FCW is input so as to control a pass band of the digital loop filter 14. The digital information output from the digital loop filter 14 is supplied to the processor 4 and also to the VCO 15.

The VCO 15 has a digital control terminal to be input with the digital information and an analog control terminal to be input with the sensing signal. The sensing signal is treated by the ADPLL circuitry 5 as a disturbance, so that the ADPLL circuitry 5 tries to cancel out the effect of disturbance by feedback control on the oscillation frequency of the oscillation signal. In this way, the digital information becomes a signal in the reverse phase of the sensing signal. If the frequency band of the sensing signal is much narrower than the loop band of the ADPLL circuitry 5, the digital information output from the digital loop filter 14 becomes a signal just in the reverse phase of the sensing signal. Accordingly, the ADPLL circuitry 5 can cancel out the effect of the sensing signal to perform ADPLL control on the oscillation frequency of the oscillation signal. The digital information output from the digital loop filter 14 is a signal acquired by digital conversion of the sensing signal with phase inversion. The digital information is supplied to the processor 4. The processor 4 can obtain a signal acquired by digital conversion of sensing information, without a dedicated A/D converter.

As described above, in the third embodiment, the ADPLL circuitry 5 for generation of the local oscillation signal can also be used for digital conversion of the sensing signal. Therefore, there is no necessity of providing an A/D converter for digital conversion of the sensing signal, and hence the internal configuration of the wireless communication apparatus 1 can be simplified.

### Fourth Embodiment

A fourth embodiment has the VCO 15 of FIG. 3, with a detailed internal configuration.

FIG. 4 is a block diagram schematically showing the configuration of a wireless communication apparatus 1 according to the fourth embodiment. The VCO 15 in the wireless communication apparatus 1 of FIG. 4 has a resonator 17 and an oscillator unit 18. FIG. 4 shows an example in which the sensing signal is MEMS (Micro Electro Mechanical Systems) capacitance 19, although not limited to the MEMS capacitance 19. The resonator 17 has resonant circuitry including at least an inductor and a capacitor. To the resonator 17, for example, the MEMS capacitance 19, which is the sensing signal, is connected. When the MEMS capacitance 19 varies, the resonance frequency of the resonator 17 varies. The oscillator 18 is configured with an LC-VCO having a positive feedback amplifier, or the like. The oscillator unit 18 generates an oscillation signal having a frequency in accordance with the resonance frequency of the resonator 17.

When the MEMS capacitance 19 varies, the resonance frequency of the resonator 17 varies, and then the oscillation frequency of the oscillator unit 18 varies accordingly. The change in the oscillation frequency of the oscillation signal is treated as a disturbance to the ADPLL circuitry 5, so that the digital information varies to cancel out the change in the oscillation frequency of the oscillation signal.

As described above, also in the fourth embodiment, the change in the oscillation frequency of the resonator 17 due to the change in the MEMS capacitance 19 is treated as a disturbance, so that digital information is generated to cancel out the disturbance, and hence the change in the MEMS capacitance 19 is generated as the digital information. The digital information is supplied to the processor 4.

### Fifth Embodiment

A fifth embodiment is one modification of the third embodiment, in which a wireless signal is transmitted with direct modulation.

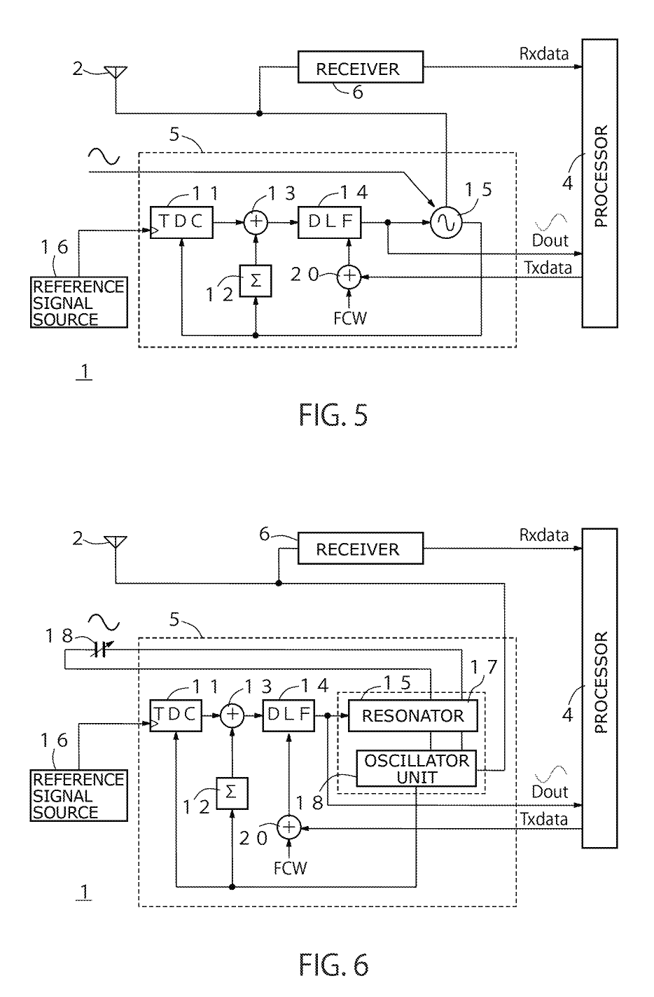

FIG. 5 is a block diagram schematically showing the configuration of a wireless communication apparatus 1 according to the fifth embodiment. The wireless communication apparatus 1 of FIG. 5 is the same as that of FIG. 3, except for being not provided with the transmitter 3 but being newly provided with an adder 20.

Transmission data output from the processor 4 is input to the adder 20. At the time of transmission, the adder 20 supplies a signal, which is acquired by adding the transmission data and a frequency control code, to the digital loop filter 14. The digital loop filter 14 outputs digital information in accordance with the output signal of the adder 20. The VCO 15 generates a transmission signal having a frequency modulated with direct modulation based on the digital information. The transmission signal is wirelessly transmitted via the antenna 2. As described above, the wireless communication apparatus 1 of FIG. 5 generates a transmission signal modulated by the ADPLL circuitry 5 with direct modulation and transmits the transmission signal via the antenna 2. Accordingly, a transmitter 3 such as shown in FIG. 3 is not required.

Reception of a wireless signal received by the antenna 2 is performed in the same manner as in FIG. 3. In this case, the VCO 15 generates a local oscillation signal and then the receiver 6 uses the local oscillation signal to convert a received signal into a baseband signal.

When the sensing signal is input, in the same manner as in FIG. 3, the digital information is generated so as to cancel out the disturbance due to the sensing signal.

As described above, in the fifth embodiment, since the transmission signal is transmitted with direct modulation, the transmitter 3 can be omitted, so that the internal configuration of the wireless communication apparatus 1 can be more simplified than that of FIG. 3.

### Sixth Embodiment

A sixth embodiment is one modification of the fourth embodiment, in which a wireless signal is transmitted with direct modulation.

FIG. 6 is a block diagram schematically showing the configuration of a wireless communication apparatus 1 according to the sixth embodiment. The wireless communication apparatus 1 of FIG. 6 is the same as that of FIG. 4, except for being not provided with the transmitter 3 but being newly provided with an adder 20.

Since the wireless communication apparatus 1 of FIG. 6 transmits a transmission signal with direct modulation in the same manner as in FIG. 5, the transmitter 3 can be omitted.

Also in the wireless communication apparatus 1 of FIG. 6, when the MEMS capacitance 19 corresponding to the sensing signal varies, the resonance frequency of the resonator 17 varies, and then the oscillation frequency of the oscillation signal of the oscillator unit 18 varies accordingly. The ADPLL circuitry 5 treats the change in the MEMS capacitance 19 as a disturbance, to generate digital information so as to cancel out the disturbance. Accordingly, the digital information becomes a signal in the reverse phase of the change in the MEMS capacitance 19.

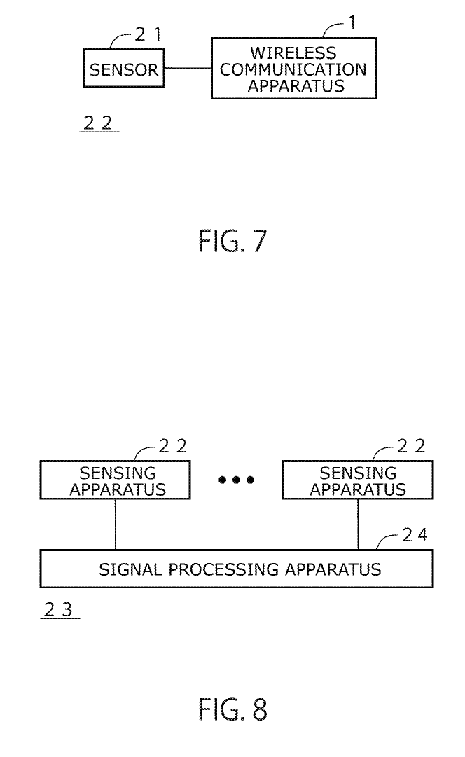

The wireless communication apparatuses 1 according to the first to sixth embodiments described above can be built in a sensor or disposed close to the sensor to configure a sensing apparatus, together with the sensor. FIG. 7 is a block diagram schematically showing the configuration of a sensing apparatus 22 provided with the wireless communication apparatus 1 of any one of the first to sixth embodiments and a sensor 21. The sensing apparatus 22 of FIG. 7 can be configured, for example, with a single semiconductor IC or mounted on a single circuit board. A target object to be sensed by the sensing apparatus 22 may not be necessarily only one. A plurality of types of sensing apparatuses 22 that sense a variety of target objects can be combined one another to perform a variety of types of signal processing.

In the case of examining whether there is degradation in large-scale structures such as bridge piers and buildings, it is considered to build a signal processing system 23 in which sensing apparatuses 22 each shown in FIG. 7 are installed in a plurality of locations in a structure, which transmit sensing signals in the form of wireless signals, which are then received at one location for overall analysis of whether there is degradation in the structure. The sensing apparatuses 22 are installed in different locations of the structure. Therefore, if each sensing apparatus 22 transmits the sensing signal in wired transmission, wirings become complicated, with a risk of disconnections or the like, requiring a material cost and a work cost for routing signal cables. It is therefore desirable for each sensing apparatus 22 to transmit the sensing signal in a manner that the wireless communication apparatus 1 in the sensing apparatus 22 transmits the sensing signal in wireless transmission. If power is supplied to each sensing apparatus 22 in a wired manner, power loss due to wirings occurs, requiring a material cost and a work cost for routing power cables. Accordingly, it is desirable to attach a renewable energy generator, such as a solar panel and a wind power generator, to each sensing apparatus 22 to supply power required for sensing, without external power supply via power cables.

FIG. 8 is a block diagram schematically showing the configuration of a signal processing system 23. The signal processing system 23 of FIG. 8 is provided with a plurality of sensing apparatuses 22 and a signal processing apparatus 24 for receiving transmission data transmitted from the sensing apparatuses 22 in wireless transmission, and for signal processing of the received transmission data. Although FIG. 8 shows one signal processing apparatus 24, a plurality of signal processing apparatuses 24 may share signal processing.

At least part of the wireless communication apparatus, the sensing apparatus, and the signal processing system explained in the embodiments may be configured with hardware or software. When it is configured with software, a program that performs at least part of the wireless communication apparatus, the sensing apparatus, and the signal processing system may be stored in a storage medium such as a flexible disk and CD-ROM, and then installed in a computer to run thereon. The storage medium may not be limited to a detachable one such as a magnetic disk and an optical disk but may be a standalone type such as a hard disk and a memory.

Moreover, a program that achieves the function of at least part of the wireless communication apparatus, the sensing apparatus, and the signal processing system may be distributed via a communication network a (including wireless communication) such as the Internet. The program may also be distributed via an online network such as the Internet or a wireless network, or stored in a storage medium and distributed under the condition that the program is encrypted, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication apparatus comprising:
a transmitter to modulate transmission data using a local oscillation signal to generate a wireless signal to be transmitted from an antenna;
a signal processor to generate the transmission data and to supply the generated transmission data to the transmitter; and
ADPLL (All Digital Phase-Locked Loop) circuitry to generate the local oscillation signal by ADPLL processing and to supply digital information correlated with an input sensing signal to the signal processor.

2. The wireless communication apparatus of claim 1, wherein the ADPLL circuitry generates the digital information so as to cancel out the sensing signal.

3. The wireless communication apparatus of claim 1, wherein the digital information is a digital signal in reverse phase of the sensing signal, and the sensing signal is a signal of a narrower band than a loop band of the ADPLL circuitry.

4. The wireless communication apparatus of claim 1, wherein the sensing signal is an alternating-current signal that at least one of a frequency, a phase and an amplitude of the alternating-current signal varies in accordance with change in at least one of capacitance, an inductor, resistance, a current and a voltage.

5. The wireless communication apparatus of claim 1, wherein the signal processor supplies the transmission data correlated with the digital information to the transmitter.

6. The wireless communication apparatus of claim 1 further comprising a receiver to demodulate a wireless signal received by the antenna, based on the local oscillation signal, thereby generating reception data,
wherein the signal processor processes the reception data generated by the receiver.

7. The wireless communication apparatus of claim 1, wherein the ADPLL circuitry comprises:
an oscillator to generate an oscillation signal having an oscillation frequency in accordance with the digital information;
a counter to count a rising- or falling-edge number of the oscillation signal;
a time-to-digital converter to convert, by digital conversion, a phase difference between a reference signal and the oscillation signal;
an adder to add a count value of the counter to an output of the time-to-digital converter; and
a digital loop filter to remove an unnecessary frequency component included in an output of the adder, thereby generating the digital information.

8. The wireless communication apparatus of claim 7, wherein the oscillator comprises:
a digital control terminal to be input with the digital information; and
an analog control terminal to be input with the sensing signal,
wherein the ADPLL circuitry generates the digital information to be input to the digital control terminal so as to cancel out the sensing signal input to the analog control terminal.

9. The wireless communication apparatus of claim 7, wherein the oscillator comprises:
a resonator to resonate at a frequency in accordance with the sensing signal; and
an oscillator unit to generate the oscillation signal having a frequency in accordance with a resonance frequency of the resonator.

10. A sensing apparatus comprising:
a sensor to output a sensing signal that at least one of a frequency, a phase and an amplitude of the sensing signal varies in accordance with change in a target to be measured; and
a wireless communication apparatus to transmit a wireless signal including information correlated with the sensing signal;
wherein the wireless communication apparatus comprises:
an antenna to transmit and receive the wireless signal;
a transmitter to modulate transmission data to generate the wireless signal to be transmitted from the antenna using a local oscillation signal;
a signal processor to generate the transmission data and to supply the generated transmission data to the transmitter; and
ADPLL (All Digital Phase-Locked Loop) circuitry to generate the local oscillation signal by ADPLL processing and to supply digital information correlated with the sensing signal to the signal processor.

11. The sensing apparatus of claim 10, wherein the ADPLL circuitry generates the digital information so as to cancel out the sensing signal.

12. The sensing apparatus of claim 10, wherein the digital information is a digital signal in reverse phase of the sensing signal, and the sensing signal is a signal of a narrower band than a loop band of the ADPLL circuitry.

13. The sensing apparatus of claim 10, wherein the sensing signal is an alternating-current signal that at least one of a frequency, a phase and an amplitude of the alternating-current signal varies in accordance with change in at least one of capacitance, an inductor, resistance, a current and a voltage.

14. The sensing apparatus of claim 10, wherein the signal processor supplies the transmission data correlated with the digital information to the transmitter.

15. The sensing apparatus of claim 10 further comprising a receiver to demodulate a wireless signal received by the antenna, based on the local oscillation signal, thereby generating reception data,
wherein the signal processor processes the reception data generated by the receiver.

16. The sensing apparatus of claim 10, wherein the ADPLL circuitry comprises:
an oscillator to generate an oscillation signal having an oscillation frequency in accordance with the digital information;
a counter to count a rising- or falling-edge number of the oscillation signal;
a time-to-digital converter to convert, by digital conversion, a phase difference between a reference signal and the oscillation signal;
an adder to add a count value of the counter to an output of the time-to-digital converter; and
a digital loop filter to remove an unnecessary frequency component included in an output of the adder, thereby generating the digital information.

17. The wireless communication apparatus of claim 16, wherein the oscillator comprises:
a digital control terminal to be input with the digital information; and
an analog control terminal to be input with the sensing signal,
wherein the ADPLL circuitry generates the digital information to be input to the digital control terminal so as to cancel out the sensing signal input to the analog control terminal.

18. The wireless communication apparatus of claim 16, wherein the oscillator comprises:
a resonator to resonate at a frequency in accordance with the sensing signal; and
an oscillator unit to generate the oscillation signal having a frequency in accordance with a resonance frequency of the resonator.

19. A signal processing system comprising:
a plurality of sensors to output sensing signals that at least one of a frequency, a phase and an amplitude of each of the sensing signals varies in accordance with change in each of different targets to be measured;
a wireless communication apparatus to transmit a wireless signal including information correlated with the sensing signals from the plurality of sensors; and
a signal processor to receive the wireless signal and to perform signal processing related to the sensing signals of the plurality of sensors,
wherein the wireless communication apparatus comprises:
an antenna to transmit and receive the wireless signal;
a transmitter to modulate transmission data to generate the wireless signal to be transmitted from the antenna using a local oscillation signal;
a signal processor to generate the transmission data and to supply the generated transmission data to the transmitter; and
ADPLL (All Digital Phase-Locked Loop) circuitry to generate the local oscillation signal by ADPLL processing and to supply digital information correlated with the sensing signal to the signal processor.

20. The signal processing system of claim 19, wherein the ADPLL circuitry generates the digital information so as to cancel out the sensing signal.
